(19) United States
(12) Patent Application Publication
(10) Pub. No.: US 2014/0222611 A1
(43) Pub. Date: Aug. 7, 2014

(54) SYSTEM AND METHOD FOR A CURATOR RECOMMENDED SALE OF COMMODITIES

(71) Applicant: Jong-Hoon OH, Seoul (KR)

(72) Inventor: Jong-Hoon OH, Seoul (KR)

(21) Appl. No.: 13/833,672

(22) Filed: Mar. 15, 2013

(30) Foreign Application Priority Data
Feb. 6, 2013 (KR) 10-2013-0013567

(51) Int. Cl. G06Q 30/06

(52) U.S. Cl. CPC G06Q 30/0631
USPC 705/26.7

(57) ABSTRACT

The present disclosure relates to a curator recommended sale system and method. The curator recommended sale system includes a commodity list generation unit configured to receive commodities for sale of a vendor from a vendor terminal, generate a list of the commodities for sale, receive recommended commodities by a curator based on the list of commodities for sale from a curator terminal, and generate a list of the recommended commodities, a payment unit configured to process payment on a recommendation commodity included in the list of recommended commodities when a purchase request for the recommendation commodity is received from the terminal of a purchaser selecting the curator, and a profit share unit configured to pay a commission to the curator according to sales of the recommendation commodity.

This application is based on and claims priority from Korean Patent Application No. 10-2013-0013567, filed on Feb. 6, 2013 with the Korean Intellectual Property Office, the disclosure of which is incorporated herein in its entirety by reference.

### BACKGROUND OF THE INVENTION

1. Technical Field

The present disclosure relates to a curator recommended sale system and method, and more particularly, to a curator recommended sale system and method in which, when a vendor registers commodities for sale and a curator evaluates the commodities for sale in an e-commerce site and recommends commodities based on a result of the evaluation, a purchaser who has selected the curator purchases the recommended commodities by the curator.

2. Background

With the development of the Internet, e-commerce is actively carried out in the Internet. Internet shopping occupies most of e-commerce. Lots of people access a variety of Internet shopping malls and purchase their desired commodities.

Numerous Internet shopping malls handle various types and huge number of commodities. People have difficulty in purchasing their desired commodities among the huge number of commodities based on pieces of oversupplied information.

In general, netizens purchase commodities with reference to basic information on the commodities and reviews of the commodities by others. As power bloggers recently appear in the Internet, netizens are increasingly purchasing commodities with reference to reviews of the commodities or recommended contents that are posted in the blogs of the power bloggers.

It is, however, difficult for netizens to refer to the blogs of power bloggers because the blogs are scattered all over the Internet. Furthermore, in most cases, the contents of a blog are not suitable for specific netizens from a viewpoint of the preferences, and life styles of the netizens.

Furthermore, since the activities of a blogger are chiefly attributed to his/her interest or self-contentment, a buyer does not compensate the blogger for any purchase attributable to the blog of the blogger, and statistics of purchases attributable to the blogs have not been known.

In addition, in the case of a shopping mall where a variety of product groups are sold, merchandising for sale promotion is inefficient and a cost therefor is increased according to an increase in the scale of the shopping mall.

### SUMMARY

The present disclosure provides a sale management server configured to receive commodities for sale from a vendor terminal, receive recommended commodities by a curator based on the commodities of a vendor from a curator terminal, and provide the recommended commodities by a curator to a terminal of a purchaser selecting the curator, and process payment on a recommended commodity when a purchase request for the recommended commodity is made by the purchaser terminal.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 shows a schematic configuration of a curator recommended sale system in accordance with the present disclosure.

FIG. 2 shows a block diagram of a sale management server in accordance with the present disclosure.

FIG. 3 is a signal flowchart illustrating a recommendation sale in the curator recommended sale system in accordance with the present disclosure.

FIG. 4 is a signal flowchart illustrating how curators associate with each other in the curator recommended sale system in accordance with the present disclosure.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

The present disclosure provides a sale system and method in which netizens may easily search the Internet for commodities suitable for their preferences and purchase the retrieved commodities.

The present disclosure provides a sale system and method in which a person who recommends commodities or provides information is given compensation if a purchase attributable to the behavior of recommending the commodities or providing the information like the activities of a blogger is made.

The present disclosure provides a sale system and method capable of significantly reducing a merchandising cost for an Internet shopping mall.

The present disclosure provides a system and method in which an independent commodity recommender spontaneously recommends commodities to buyers having the same preferences as the commodity recommender. Thus, an Internet shopping mall manager does not need directly select commodities for a discount or regular price sale.

As described above, in accordance with the present disclosure, since a buyer may select a curator having the same preference or style as the buyer and purchase a commodity recommended by the curator, the buyer neither need to search a shopping mall for a commodity to be purchased, check the retrieved commodity, update a new product, nor receive a recommendation for an uninterested commodity from a shopping mall. Accordingly, there is an advantage in that a buyer may receive a recommendation for only an optimal commodity suitable for his preference or style and purchase the recommended commodity.

Furthermore, in accordance with the present disclosure, a seller may easily sell his commodities and sales increases because a curator recommends commodities for sale of the seller to purchasers. If the recommended commodity by any curator is well matched with the preference of a purchaser, the purchaser waits for future commodity recommendations by the corresponding curator. Accordingly, the sale of commodities are promoted.

Furthermore, if conventional power bloggers, social networkers, or distributors and people who will become new merchandisers work as curators in accordance with the present disclosure, they may receive commissions in proportion to sales performance when purchasers who have selected the curators purchase commodities. Accordingly, new occupations and incomes may be created by cultivating merchandisers. The curator candidates have a burden on independently operating blogs or shopping malls in a conventional e-commerce structure and separately managing a product inventory. If the curators enter the system in accordance with the present disclosure, this burden is solved once for all.

Furthermore, a curator who has become famous by merchandising a high-quality commodity that complies with a specific preference becomes one brand, leads a commodity trend, and comes into spotlight from purchasers. By disclosing an evaluation of a curator by purchasers and sales performance of a recommended commodity to the purchasers, a competition between curators is triggered and a system for verifying and monitoring the curators may be secured.

Furthermore, an Internet shopping mall site may significantly reduce a merchandising cost. Merchandising is one of marketing activities. Merchandising is a term used according to a marking view, meaning that a demand is not produced naturally, but should be actively created. Merchandising is a term that is understood from a viewpoint that it is necessary to thoroughly examine a consumer's behavior, stimulate the consumer's demand, and fabricate or select a commodity suitable for the demand by taking a cost of production into consideration. Recently, merchandising is being used as a broad meaning including merchandising, sales promotion, and advertising campaign activities, and simple merchandising is also called product planning. An existing Internet shopping mall is problematic in that merchandising may be inefficient according to an increase in the scale of the Internet shopping mall and a cost for the merchandising is increased when additional human power is hired. In merchandising in accordance with the present disclosure, a merchandiser independent from a shopping mall, that is, a curator, spontaneously takes part in the merchandising instead of a shopping mall.

Furthermore, the sale management server of the present disclosure may have the aforementioned technical effects whether it is implemented in a new shopping mall site, or in an existing famous shopping mall site, which however, may create a greater synergy effect than the new shopping mall site.

Prior to the detailed description of the present disclosure, it is to be noted that the same reference numerals denote the same elements throughout the drawings even in cases where the elements are shown in different drawings, and in describing the embodiments of the present disclosure, a detailed description of some known constituent elements will be omitted.

First, terms used in the specification of the present disclosure are defined below.

A purchaser refers to a member who has subscribed to an e-commerce site for purposes of purchasing commodities. A purchaser can select a curator and read the recommended commodities by a curator.

A vendor refers to a member who has subscribed to an e-commerce site for purposes of selling commodities.

A curator refers to a member who has subscribed to an e-commerce site for purposes of searching for commodities registered or not registered by vendors, evaluating and selecting the retrieved commodities based on a specific preference or style, providing recommended commodities to purchasers, and arranging sale while negotiating the price of commodities with the vendor, if necessary. A curator may maintain purchasers and receive a commission when his/her purchaser purchases a commodity.

For example, a specific preference or style may be a style of a famous entertainer, but not limited thereto. If a curator discovers and recommends clothes or accessories matched with a famous entertainer, the curator may maintain purchasers who want to follow a style or preference of the famous entertainer. For another example, a specific preference or style may be a classical brand-name style, from among men's clothes.

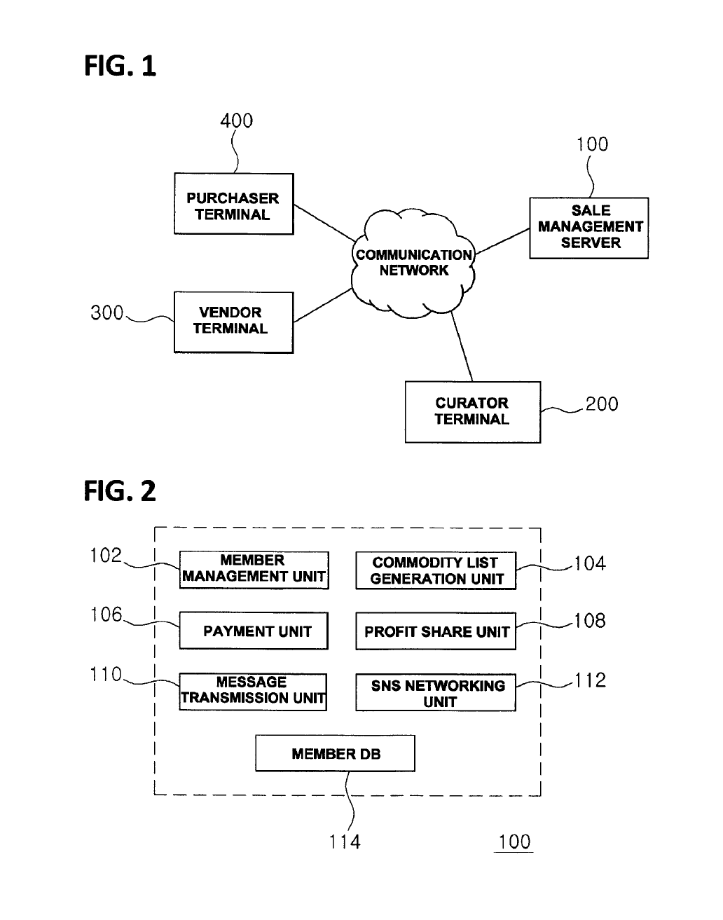

FIG. 1 shows a schematic configuration of a curator recommended sale system in accordance with the present disclosure.

Referring to FIG. 1, the curator recommended sale system includes a sale management server 100, a curator terminal 200, a vendor terminal 300, and a purchaser terminal 400.

Sale management server 100 performs the recommended sale service between curator terminal 200, vendor terminal 300, and purchaser terminal 400. Sale management server 100 provides the recommended commodities by a curator to a purchaser who selects the curator and processes payment on a recommended commodity when a purchaser makes a purchase request. That is, sale management server 100 receives commodities for sale registered by vendor terminal 300, receives recommended commodities registered by the curator of curator terminal 200, and provides the recommended commodities to purchaser terminal 400.

Curator terminal 200 refers to a terminal used by a curator. The curator evaluates commodities for sale registered by a vendor, selects commodities based on a result of the evaluation, and inputs recommended commodities through curator terminal 200.

Vendor terminal 300 refers to a terminal used by a vendor. The vendor inputs commodities for sale through vendor terminal 300. The commodities presented for sale may be classified into commodities that may be accessed by curators and commodities that may be accessed by both curators and purchasers. The presented commodities also may be classified depending on whether they will be regularly sold at a regular price to purchasers or whether they will be sold at a discounted price in large quantities through curators.

Purchaser terminal 400 refers to a terminal used by a purchaser who purchases commodities. The purchaser may purchase a desired commodity by checking the recommended commodities by a curator that are provided through sale management server 100. The purchaser may check a commodity recommendation by accessing sale management server 100 or reading a message received from sale management server 100. If a purchaser selects a plurality of curators, ranking may be assigned to each of the plurality of curators according to the purchaser's preference for the curators and the purchaser may read information on recommended commodities according to the ranking of the curators.

Each of curator terminal 200, vendor terminal 300 and purchaser terminal 400 may be a desktop computer, a laptop computer, a tablet PC, or a smart phone, but not limited thereto. Any type of a device capable of accessing sale management server 100 and receiving a recommendation sale function from sale management server 100 may be used as curator terminal 200, vendor terminal 300 and purchaser terminal 400.

FIG. 2 shows a block diagram of sale management server 100 in accordance with the present disclosure.

Referring to FIG. 2, sale management server includes a member management unit 102, a commodity list generation unit 104, a payment unit 106, a profit share unit 108, a message transmission unit 110, an SNS networking unit 112, and a member DB 114.

Member management unit 102 classifies members into curators, vendors, and purchasers and manages the members.

Since anyone may become a purchaser, member management unit 102 qualifies a purchaser candidate for membership as a purchaser when receiving personal information and a purchaser subscription request from the person. Here, a purchaser designates a curator, and member management unit 102 checks whether the purchaser has designated a curator or not. Member management unit 102 manages the purchase history (for example, the amount of purchases, the number of purchases, and purchased commodities) of the purchaser.

Anyone who sells commodities may be allowed to become a vendor, or a specific candidate may be allowed to become a vendor based on the person's credit or past sale details. When receiving pieces of information, such as a business license number, commodities for sale, and a bank account, and a vendor subscription request from a person, member management unit 102 qualifies a vendor candidate for membership as a vendor. Member management unit 102 manages the sales history (for example, a list of commodities for sale, the amount of sales, the number of sale, and sold commodities) of the vendor.

Anyone may be allowed to become a curator, or a specific person only may be allowed to become a curator when the person meets specific requirements. Member management unit 102 evaluates the qualifications of the curator and determines a grade of the curator based on a result of the evaluation.

Parameters used to examine a curator candidate for membership may be various. Member management unit 102 may examine a curator candidate for membership by using the number of followers in a social network, the amount of purchases, the number of purchases, and the number of positive feedbacks on a purchased commodity from a purchaser, and qualify the curator candidate for membership as a curator when the candidate meets a specific mark. Specific weight may be applied to each parameter and a mark for a curator candidate for membership may be given in consideration of the weights.

Member management unit 102 gives a mark for a curator by using the number of purchasers belonging to the curator, sales performance (for example, the amount of sales and the number of sale) of recommended commodities, and evaluation of the curator by purchasers, and determines a grade of the curator according to the mark. Parameters used to determine a grade of a curator may be various, and mark for determining a grade of a curator may be given by applying specific weight to each parameter and adding the weighted points for each of parameters.

Member management unit 102 may provide a purchaser with a question related to a commodity, a design, and a life style so that the purchaser may easily select a curator having a similar preference to the purchaser. For example, a purchaser may be questioned about a style of favorite clothes, favorite shoes, favorite food, age, sex, and a place of residence, and may also be questioned about whether he/she prefer a commodity recommended by a curator. A curator may also participate in answering the same question presented to a purchaser. Member management unit 102 may recommend a curator suitable for a purchaser to the purchaser on the basis of similarity between answers to questions made by the purchaser and the curator.

Member management unit 102 may provide a purchaser with information on the recommendation of a curator as per the curator's ranking or grade. Member management unit 102 may recommend a curator to a purchaser according to a commodity field, or may provide a purchaser with demographic data such as age, sex, an address, and an occupation regarding another purchaser who selects a curator.

Furthermore, member management unit 102 may provide a purchaser with commodities scheduled to be sold and commodities sold in the past, of a curator, or blog posting contents that introduce the curator's preference.

Commodity list generation unit 104 receives commodities for sale of a vendor from vendor terminal 300 and generates a list of the commodities for sale. The list of commodities for sale is provided to curator terminal 200.

Furthermore, commodity list generation unit 104 receives the recommended commodities by a curator based on a list of commodities for sale from curator terminal 200 and generates a list of the recommended commodities. The list of the recommended commodities is provided to purchaser terminal 400 of a purchaser who selects the corresponding curator.

Payment unit 106 processes payment on a recommended commodity included in a list of recommended commodities when a purchase request for the recommended commodity is received from purchaser terminal 400 of a purchaser who selects a curator. Payment unit 106 may include a variety of payment modules so that payment may be processed in cash, credit card, coupon, or electronic money.

Profit share unit 108 pays a commission to a curator according to sales performance of a recommended commodity by the curator. The commission may be paid by a vendor, or the operator of the sale management server and the vendor may share the commission to be paid to the curator. Profit share unit 108 may adjust a rate of the commission based on a grade of the curator.

Message transmission unit 110 transmits an advertising message relating to a list of recommended commodities to purchaser terminal 400 of a purchaser who selects a curator, when vendor terminal 300 approves the start of sale for the list of recommended commodities. Furthermore, message transmission unit 110 may be configured to send an advertising message even without approval of the start of sale from vendor terminal 300. Furthermore, message transmission unit 110 transmits a payment processing result message to curator terminal 200 and vendor terminal 300 when payment processing for a commodity is completed.

SNS networking unit 112 is a part communicating with a social network. SNS networking unit 112 transmits information related to a recommendation sale and a discount sale to subscribers to a social network, for example, Pinterest, Twitter, and Facebook. SNS networking unit 112 may transmit a list of recommended commodities to the followers of a curator over a social network.

Member DB 114 stores information on members, such as purchasers, vendors, and curators and also stores information on a list of commodities including a list of commodities for sale of vendors and a list of commodities recommended by curators.

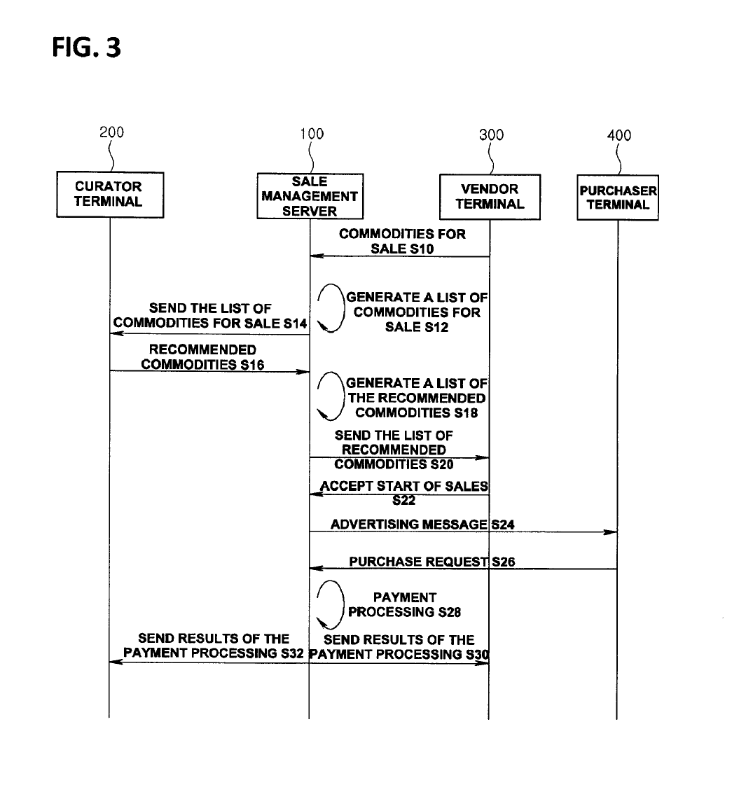

FIG. 3 is a signal flowchart illustrating a recommendation of sale in the curator recommended sale system in accordance with the present disclosure.

Referring to FIG. 3, first, vendor terminal 300 inputs commodities for sale and transmits the inputted commodities to sale management server at step S10.

Sale management server 100 receives the commodities for sale from vendor terminal 300, generates a list of the commodities for sale at step S12, and stores the list of commodities for sale in member DB 114. Sale management server 100 transmits the list of commodities for sale to curator terminal 200 at step S14.

The curator of curator terminal 200 accesses sale management server, reads the list of commodities for sale, and transmits recommended commodities among the list of commodities for sale to sale management server at step S16. If the list of commodities for sale does not include commodities that curator terminal 200 wish to recommend, the curator of curator terminal 200 may request the corresponding commodities from a vendor who is expected to source the corresponding commodities. Furthermore, the curator of curator terminal 200 may retrieve information presented by a vendor, including a discount sale period, a minimum number of buyers at which sale may be started, and a discounted price according to an expected number of buyers, and suggest the number of members belonging to the curator while requesting a discount to the vendor.

Sale management server 100 receives the recommended commodities from curator terminal 200, generates a list of the recommended commodities at step S18, and stores the list of recommended commodities in member DB 114. Sale management server 100 transmits the list of recommended commodities, a discount sale request of curator terminal 200, and the number of purchasers if the purchasers have been collected in advance, to vendor terminal 300 with which commodities for sale belonging to the list of recommended commodities have been registered at step S20.

Vendor terminal 300 checks the list of recommended commodities and determines whether or not to accept the start of sale for the list of recommended commodities. If vendor terminal 300 informs disapproval of the start of sale, sale for the recommended commodities are not performed. If vendor terminal 300 informs approval of the start of sale, sale for the recommended commodities starts at step S22. If curator terminal 200 does not request a discount sale to the vendor, the step S22 of approving the start of sale may be omitted.

In response to the approval of the start of sale received from vendor terminal 300, sale management server transmits an advertising message relating to the list of recommended commodities to purchaser terminal 400 of the purchaser who selects the curator at step S24. If a curator want to collect purchasers who want to purchase a recommended commodity in advance before curator terminal 200 receives the approval of the start of sale from vendor terminal 300, an advertising message for advance notice of sale may be transmitted to the purchasers. If sale are terminated, a sale termination message may be transmitted to the purchasers.

The purchaser of purchaser terminal 400 checks the list of recommended commodities and requests a purchase for a desired recommended commodity from sale management server based on a result of the check at step S26. The purchaser of purchaser terminal 400 may access sale management server at any time without step 24 of the server's transmitting an advertising message to a purchaser terminal, or access the sale management server after receiving the advertising message; read a list of recommended commodities by a curator that is selected by the purchaser; and request a purchase for a desired recommended commodity from sale management server. If a plurality of curators is selected, the purchaser may assign ranking to the curators and read information on recommended commodities by the curators according to the ranking of the curators.

In response to the purchase request received from purchaser terminal 400, sale management server processes payment on the recommended commodity for which the purchase request has been made at step S28 and transmits a result of the payment processing to vendor terminal 300 and curator terminal 200 at steps S30 and S32.

When the payment on a recommended commodity is completed, sale management server requests vendor terminal 300 to deliver the purchased commodity. The delivery of the recommended commodity may be performed through a distribution system associated with the vendor or may be performed through a distribution system associated with the manager of sale management server.

When the payment or delivery of the purchased commodity is completed, the profit share unit 108 of sale management server pays a recommendation commission to the curator and pays the vendor an amount, exclusive of the commission of sale management server and the recommendation commission of the curator from a selling price. Sale management server 100 may apply a different commission to each of curators on the basis of sales performance and a grade thereof.

Sale management server 100 may evaluate the curator who has recommended the purchased commodity. The contents of the evaluation may include all contents regarding a curator's qualification and performance, such as quality of a recommended commodity, and quality of the curator's guidance of the recommended commodity, and quality of a response to a question or suggestion from the purchaser.

The purchaser of purchaser terminal 400 may receive a question related to a commodity, a design, and a life style from sale management server in order to select a curator. The purchaser may receive a recommendation for a suitable curator through a process of responding to the question and select the recommended curator as his curator. Furthermore, the purchaser may receive information on the recommendation of a curator as per ranking or grade of the curator from sale management server.

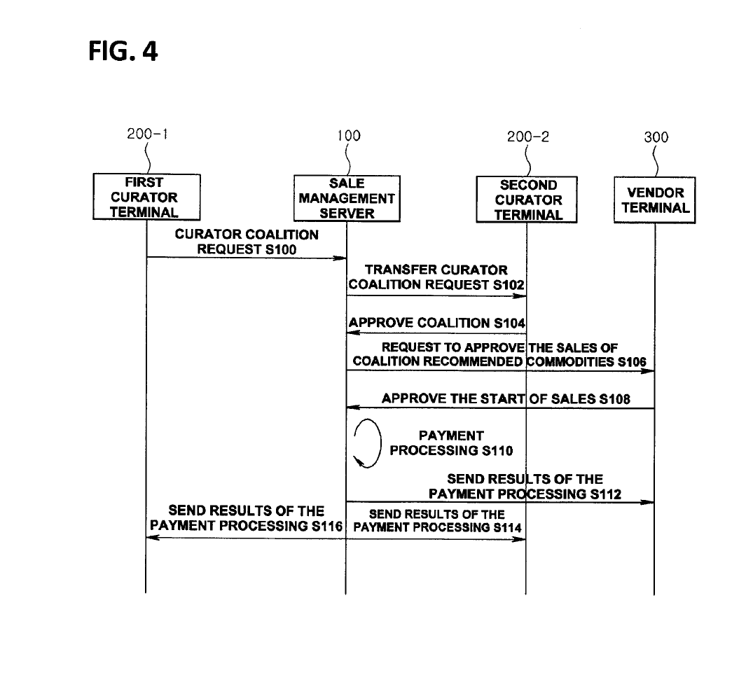

FIG. 4 is a signal flowchart illustrating how curators associate with each other in the curator recommendation sale system in accordance with the present disclosure.

In the present embodiment of the present disclosure, a plurality of curators may perform a recommendation sale through mutual coalition. That is, one curator, who has known that another curator is performing a recommendation sale or tries to perform a recommended sale for the same commodity, may request curator coalition to another curator.

Referring to FIG. 4, a curator terminal that requests curator coalition is called a first curator terminal 200-1, and a curator terminal for which a curator coalition request is made is called a second curator terminal 200-2.

First curator terminal 200-1 transmits a curator coalition request to sale management server at step S100. Sale management server 100 transfers the curator coalition request of first curator terminal 200-1 to second curator terminal 200-2 at step S102.

When second curator terminal 200-2 approves the curator coalition request at step S104, sale management server requests vendor terminal 300 to approve sale of commodities recommended by the coalition between the curators of first curator terminal 200-1 and the second curator terminal 200-2 by transmitting a list of recommended commodities to vendor terminal 300 at step S106.

When receiving approval of the start of sale for the list of recommended commodities from vendor terminal 300, sale management server transmits the list of recommended commodities by the coalition to purchaser terminal 400. When receiving a purchase request for a recommended commodity from purchaser terminal 400, sale management server processes payment on the recommended commodity at step S110.

Sale management server 100 transmits a result of the payment processing to vendor terminal 300, first curator terminal 200-1, and second curator terminal 200-2 at steps S114 and S116.

Meanwhile, the aforementioned curator recommendation sale method may be implemented in the form of a software program recorded on a computer-readable recording medium.

For example, the recording medium may be a hard disk, flash memory, RAM, or ROM which is an embedded type in each play device or may be an optical disk, such as CD-R or CD-RW, a compact flash card, a smart medium, a memory stick, or a multimedia card which is an external type.

The program recorded on the computer-readable recording medium may execute a curator recommendation sale method, including receiving commodities for sale of a vendor from the vendor terminal and generating a list of the commodities for sale, receiving recommended commodities by a curator based on the list of commodities for sale from the curator terminal and generating a list of the recommended commodities, and processing payment on a recommended commodity included in the list of recommended commodities when a purchase request for the recommended commodity is received from the purchaser terminal of a purchaser the selects the curator.

The functional operation and implementation described in the specification of the present disclosure may be embodied in a digital electronic circuit, be implemented in the form of computer software, firmware, or hardware, or be implemented by a combination of one or more of the computer software, firmware, and hardware. The implementation described in the specification of the present disclosure may be embodied in the form of one or more computer program products, that is, in the form of one or more modules regarding a computer program command that are encoded in a program storage medium for purposes of control the operation of a data processor or execution by the data processor.

Although the drawings of the present disclosure illustrate operational processes, it is not to be understood that the operations may be performed only according to the illustrated order in order to obtain some results. In a specific case, multicasting or parallel processing may be advantageous.

Furthermore, specific embodiments have been described in the specification of the present disclosure. The embodiments fall within the following claims. For example, operations written in the claims may achieve some results while being executed in different order.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A sale management server configured to:
receive commodities for sale from a vendor terminal,
receive recommended commodities by a curator based on the commodities of a vendor from a curator terminal, and
provide the recommended commodities by a curator to a terminal of a purchaser selecting the curator, and process payment on a recommended commodity when a purchase request for the recommended commodity is made by the purchaser terminal.

2. A sale management server of claim 1, comprising:
a commodity list generation unit configured to receive commodities for sale of the vendor from the vendor terminal, generate a list of the commodities, receive recommended commodities by the curator based on the list of commodities from the curator terminal, and generate a list of the recommended commodities;
a payment unit configured to process payment on a recommended commodity included in the list of recommended commodities by a curator when the purchase request for the recommended commodity is received from a terminal of the purchaser selecting the curator; and
a profit share unit configured to pay a commission to the curator according to sales of the recommended commodity.

3. The sale management server of claim 2, wherein the recommended commodities are selected according to a specific preference or style of a curator.

4. The sale management server of claim 2, further comprising a message transmission unit configured to transmit an advertising message for a list of the recommended commodities by a curator to the terminal of the purchaser selecting the curator, and inform the curator terminal and the vendor terminal of a result of the payment processing for the recommended commodity when the payment processing is completed.

5. The sale management server of claim 2, further comprising a member management unit configured to qualify a curator candidate for membership and determine a grade of the curator.

6. The sale management server of claim 5, wherein the member management unit grants qualification for the curator membership based on at least one of a number of followers in a social network, an amount of purchases, a number of purchases, and a number of positive feedback on a purchased commodity from a purchaser.

7. The sale management server of claim 5, wherein the member management unit determines the grade of the curator based on at least one of a number of purchasers belonging to the curator, sales performance of the recommended commodities, and evaluation of the curator by the purchasers.

8. The sale management server of claim 2, further comprising a social network association unit configured to transmit a list of the recommended commodities over a social network.

9. A curator recommended sale method implemented in an Internet, comprising:
receiving commodities for sale from a vendor terminal and generating a list of the commodities for sale;
receiving recommended commodities by a curator based on the list of commodities for sale from a curator terminal and generating a list of the recommended commodities; and
processing payment on a recommended commodity included in the list of recommended commodities by a curator when a purchase request for the recommended commodity is received from a terminal of a purchaser selecting the curator.

10. The curator recommendation sale method of claim 9, further comprising paying a commission to the curator according to sales of the recommended commodity.

11. The curator recommendation sale method of claim 9, wherein the recommended commodities are selected according to a specific preference or style of the curator.

12. The curator recommendation sale method of claim 9, further comprising:
transmitting an advertising message for a list of the recommended commodities by the curator to the terminal of the purchaser selecting the curator; and
informing the curator terminal and the vendor terminal of a result of the payment processing for the recommended commodity when the payment processing therefore is completed.

13. The curator recommendation sale method of claim 9, further comprising qualifying a curator candidate for membership based on at least one of a number of followers in a social network, an amount of purchases, a number of purchases, and a number of positive feedback on a purchased commodity from a purchaser.

14. The curator recommendation sale method of claim 9, further comprising determining a grade of the curator based on at least one of a number of purchasers belonging to the curator, sales performance of the recommended commodities, and an evaluation of the curator by the purchasers.

15. The curator recommendation sale method of claim 9, further comprising transmitting a list of the recommended commodities over a social network.

16. The curator recommendation sale method of claim 9, further comprising transferring a sourcing request of the curator for a commodity not included in the list of commodities for sale, or a discount request of the curator for the recommended commodities to the vendor terminal.

17. The curator recommendation sale method of claim 9, further comprising providing a question related to a commodity, a design, and a life style to a purchaser terminal so that the purchaser is able to select a curator.

18. The curator recommendation sale method of claim 9, further comprising:
receiving a coalition request with another curator from a curator terminal;
receiving coalition approval from said another curator terminal receiving the coalition request; and
requesting the vendor terminal to approve sale of commodities recommended by the coalition between the curators.

19. The curator recommendation sale method of claim 9, further comprising providing information on recommendation of curators to the purchaser terminal according to ranking of the curators.

20. A computer-readable recording medium on which a program for executing the method according to any one of claim 9 is recorded.
